(19) United States
(12) Patent Application Publication
(10) Pub. No.: US 2026/0330794 A1
(43) Pub. Date: Oct. 22, 2026

(54) DEGREE-OF-IMPORTANCE ASSESSMENT SYSTEM, DEGREE-OF-IMPORTANCE ASSESSMENT DEVICE, AND DEGREE-OF-IMPORTANCE ASSESSMENT METHOD

(71) Applicant: NEC Corporation, Minato-ku, Tokyo (JP)

(72) Inventors: Hayato ITSUMI, Tokyo (JP); Koichi NIHEI, Tokyo (JP); Masaharu MORIMOTO, Tokyo (JP); Florian BEYE, Tokyo (JP)

(73) Assignee: NEC Corporation, Minato-ku, Tokyo (JP)

(21) Appl. No.: 19/119,451

(22) PCT Filed: Oct. 14, 2022
(86) PCT No.: PCT/JP2022/038458

§ 371 Date: Apr. 9, 2025

(51) Int. Cl. G06V 10/25; G06N 5/04; G06V 10/77

(52) U.S. Cl. CPC G06V 10/25; G06N 5/04; G06V 10/7715

(57) ABSTRACT

A degree-of-importance determination system (100) includes: a specifying means (101) that specifies a plurality of regions in at least one input image; a feature calculation means (102) that calculates features of the respective plurality of regions; and a determination means (103) that generates, on the basis of the features of the respective plurality of regions, relationship information indicative of a relationship between the features of the respective plurality of regions and determines a degree of importance of each of the plurality of regions on the basis of the relationship information.

### TECHNICAL FIELD

The present invention relates to a degree-of-importance determination system, a degree-of-importance determination apparatus, and a degree-of-importance determination method.

### BACKGROUND ART

A technology for dividing and processing an input image during image analysis of the input image is known. For example, Patent Literature 1 discloses an image analyzing apparatus that includes: a partial image division section which reprojects an input image in a plurality of different directions to divide the input image into a plurality of partial images; a feature extraction section which extracts a feature from each of the partial images; a degree-of-importance calculation section which calculates, from the extracted feature in accordance with a predetermined regression model, a degree of importance of the input image by position; an attention-point-likelihood-distribution calculation section which calculates a likelihood distribution of an attention point from the calculated degree of importance in accordance with the predetermined regression model; and an attention point calculation section which calculates the attention point on the basis of the likelihood distribution of the attention point.

### CITATION LIST

### Patent Literature

### Patent Literature 1

Japanese Patent Application Publication, Tokukai, No. 2018-22360

### SUMMARY OF INVENTION

### Technical Problem

Although Patent Literature 1 indicates that a degree of importance of an input image by position is calculated in accordance with a predetermined regression model, it will be useful if it is possible to provide a technology for more accurately determining a degree of importance.

An example aspect of the present invention has been made in view of the above problem, and an example object thereof is to provide a degree-of-importance determination system, a degree-of-importance determination apparatus, and a degree-of-importance determination method each of which makes it possible to determine a degree of importance accurately.

### Solution to Problem

A degree-of-importance determination system according to an example aspect of the present invention is a degree-of-importance determination system for determining a degree of importance of each of a plurality of regions in at least one input image, the degree-of-importance determination system including: a specifying means that specifies the plurality of regions in the at least one input image; a feature calculation means that calculates features of the respective plurality of regions; and a determination means that generates, on the basis of the features of the respective plurality of regions, relationship information indicative of a relationship between the features of the respective plurality of regions and determines the degree of importance of each of the plurality of regions on the basis of the relationship information.

A degree-of-importance determination apparatus according to an example aspect of the present invention is a degree-of-importance determination for apparatus determining a degree of importance of each of a plurality of regions in at least one input image, the degree-of-importance determination apparatus including: a specifying section that specifies the plurality of regions in the at least one input image; a feature calculation section that calculates features of the respective plurality of regions; a feature calculation means that calculates features of the respective plurality of regions; and a determination section that generates, on the basis of the features of the respective plurality of regions, relationship information indicative of a relationship between the features of the respective plurality of regions and determines the degree of importance of each of the plurality of regions on the basis of the relationship information.

A degree-of-importance determination method according to an example aspect of the present invention is a degree-of-importance determination method for determining a degree of importance of each of a plurality of regions in at least one input image, the degree-of-importance determination method including: specifying the plurality of regions in the at least one input image; calculating features of the respective plurality of regions; a feature calculation means that calculates features of the respective plurality of regions; and generating, on the basis of the features of the respective plurality of regions, relationship information indicative of a relationship between the features of the respective plurality of regions and determining the degree of importance of each of the plurality of regions on the basis of the relationship information.

### Advantageous Effects of Invention

According to an example aspect of the present invention, it is possible to determine a degree of importance accurately.

### BRIEF DESCRIPTION OF DRAWINGS

FIG. 1 is a block diagram illustrating an example configuration of a degree-of-importance determination system according to a first example embodiment.

FIG. 2 is a flowchart illustrating an example of a flow of a degree-of-importance determination method according to the first example embodiment.

FIG. 3 is a block diagram illustrating an example configuration of a degree-of-importance determination apparatus according to the first example embodiment.

FIG. 4 is a block diagram illustrating an example configuration of a degree-of-importance determination control system and a processing system according to a second example embodiment.

FIG. 5 is a schematic view illustrating an example of regions specified by a specifying means in the second example embodiment.

FIG. 6 is a schematic view schematically illustrating an example of a self-attention model.

FIG. 7 is a flowchart illustrating an example of a learning method for generating a learned model.

FIG. 8 is a block diagram illustrating an example configuration of a degree-of-importance determination system that carries out a learning method.

FIG. 9 is a schematic view illustrating an example of regions specified by a specifying means in a third example embodiment.

FIG. 10 is a block diagram illustrating an example configuration of a computer.

### EXAMPLE EMBODIMENTS

### First Example Embodiment

The following description will discuss in detail a first example embodiment of the present invention, with reference to drawings. The present example embodiment is an embodiment serving as a basis for example embodiments described later.

### (Configuration of Degree-of-Importance Determination System)

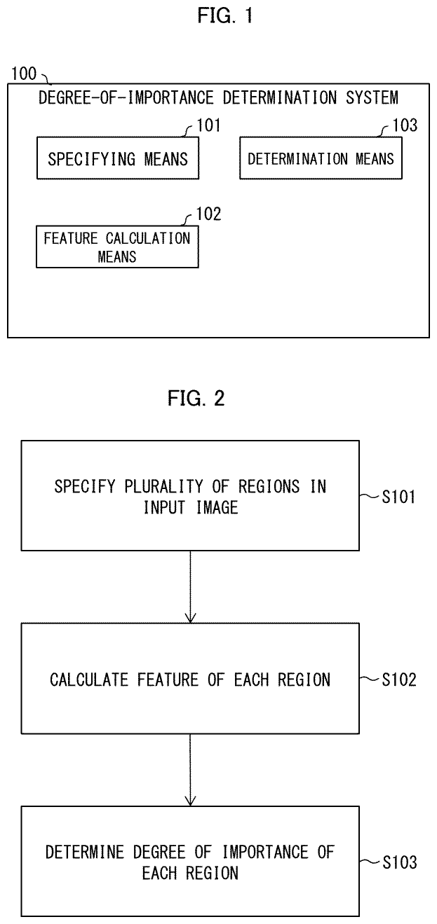

The following description will discuss a configuration of a degree-of-importance determination system according to the present example embodiment, with reference to FIG. 1. FIG. 1 is a block diagram illustrating an example configuration of a degree-of-importance determination system 100 according to the first example embodiment. The degree-of-importance determination system 100 includes a specifying means 101, a feature calculation means 102, and a determination means 103 and determines a degree of importance of each of a plurality of regions in at least one input image.

The at least one input image may each be an image captured by a camera connected to the degree-of-importance determination system 100 or an image transmitted to the degree-of-importance determination system 100 via a network. In a case where the at least one input image is a camera-captured image(s), there may be a single camera or a plurality of cameras. The camera(s) may each be an omnidirectional camera, a panorama camera, or the like.

The degree of importance is an index used for a predetermined process based on the at least one input image. For example, the manner in which the process is carried out may be changed in accordance with the degree of importance, or a flow of data in the process may be changed in accordance with the degree of importance. The predetermined process based on the at least one input image is not limited to any particular one. For example, the predetermined process may be a process of analyzing an analysis target shown in the at least one input image. The analysis target is not particularly limited, but is, for example, a worker (person) who works at a construction site, a work apparatus (object), and a behavior (operation) of the worker or the work apparatus.

In the present specification, “analyze” means to detect that an event to be detected has occurred in the analysis target. For example, in a case where the analysis target is a worker (person) who works at a construction site, a work apparatus (object), a behavior (operation) of the worker or the work apparatus, or the like, examples of an analysis result include a detection result that indicates that an event such as an inefficient operation, a procedural error, or a dangerous act has occurred.

In an example aspect, in a case where the degree of importance is an index used for analysis of the at least one input image, the degree of importance may mean the necessity to carry out the analysis. In this case, the degree of importance can be determined to be high in a case where an event to be detected in the analysis is highly likely to have occurred or in a case where an object to be detected in the analysis is highly likely to be present. Such a “degree of importance” can be reworded as a “degree of notability”, a “degree of need of attention”, a “degree of risk”, and the like. Examples of an event for which the degree of importance is high include, but are not limited to, an operation according to the intended process, an operation deviating from the intended process, and an operation having a high risk. Examples of an object for which the degree of importance is high include, but are not limited to, a person and heavy equipment. Further, the determination may be made on the basis of detectability. For example, for a person or an object that is very small in the image and difficult to detect, the degree of importance may be lowered. The method of representation of the degree of importance is not particularly limited, but may be, for example, binary representation of “0” (low degree of importance) and “1” (high degree of importance), representation using multiple (three or more) values (e.g., high, middle, and low), or representation using consecutive numerical values.

The specifying means 101 specifies a plurality of regions in at least one input image inputted to the degree-of-importance determination system 101.

The method by which the specifying means 101 specifies the plurality of regions is not particularly limited. The specifying means 101 may: specify regions corresponding to portions which have been preset in the at least one input image and a degree of importance of each of which is to be determined; specify regions which are detected by an object detection process carried out with respect to the at least one input image and each of which encloses an object; or specify regions obtained by dividing the at least one input image into equally spaced segments.

The feature calculation means 102 calculates features of the respective plurality of regions specified by the specifying means 101. The method of calculating the features is not particularly limited, and various known algorithms can be used.

The determination means 103 (i) generates, on the basis of the features of the respective plurality of regions calculated by the feature calculation means 102, relationship information indicative of a relationship between the features of the respective plurality of regions and (ii) determines a degree of importance of each of the plurality of regions on the basis of the relationship information. In an example aspect, the relationship information indicates, with respect to a degree of importance of each of the plurality of regions, an extent to which a region other than the each of the plurality of regions is related to the degree of importance. In other words, the relationship information indicates a relationship between the plurality of regions such that, for each region, a region necessary for determining a degree of importance of the each region is closely related, and a region not necessary for determining the specific region is remotely related. Examples of such relationship information include an attention weight used in an attention mechanism such as a self-attention mechanism.

Thus, according to the degree-of-importance determination system 100 according to the present example embodiment, it is possible to determine a degree of importance accurately. That is, since relationship information is generated on the basis of features of at least one input image, it is possible to determine a degree of importance with use of the relationship information which is in accordance with the at least one input image. This makes it possible for the degree-of-importance determination system 100 to determine a degree of importance accurately.

### (Flow of Degree-of-Importance Determination Method)

The following description will discuss a flow of a degree-of-importance determination method S100 according to the present example embodiment, with reference to FIG. 2. FIG. 2 is a flowchart illustrating an example of the flow of the degree-of-importance determination method S100 according to the first example embodiment. In the example illustrated in FIG. 2, the degree-of-importance determination system 100 carries out the degree-of-importance determination method S100.

In step S101, the specifying means 101 specifies a plurality of regions in at least one input image. In step S102, the feature part calculation means 102 calculates features of the respective plurality of regions. In step S103, the determination means 103 (i) generates, on the basis of the features of the respective plurality of regions, relationship information indicative of a relationship between the features of the respective plurality of regions and (ii) determines a degree of importance of each of the plurality of regions on the basis of the relationship information.

As described above, in the process control method S100 according to the present example embodiment, a degree of importance of each of a plurality of regions is determined with use of a learned model which generates relationship information on the basis of features of at least one input image. This makes it possible to determine a degree of importance with use of relationship information that is in accordance with at least one input image and thus to determine the degree of importance accurately.

### (Configuration of Degree-of-Importance Determination Apparatus)

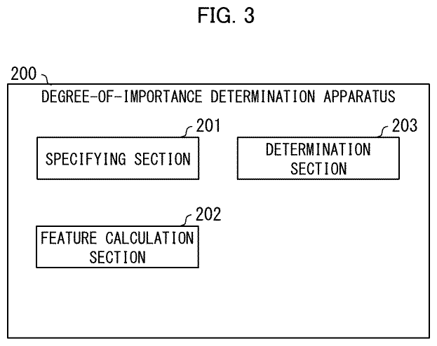

The following description will discuss a configuration of a degree-of-importance determination apparatus 200 according to the present example embodiment, with reference to FIG. 3. FIG. 3 is a block diagram illustrating a configuration of the degree-of-importance determination apparatus 200 according to the first example embodiment. The degree-of-importance determination apparatus 100 includes a specifying section 201, a feature calculation section 202, and a determination section 203 and determines a degree of importance of each of a plurality of regions in at least one input image.

The specifying section 201 has a function equivalent to that of the specifying means 101 and specifies a plurality of regions in at least one input image. The feature part calculation section 202 has a function equivalent to that of the feature part calculation means 102 and calculates features of the respective plurality of regions. The determination section 203 has a function equivalent to that of the determination means 103. The determination section 203 (i) generates, on the basis of the features of the respective plurality of regions, relationship information indicative of a relationship between the features of the respective plurality of regions and (ii) determines a degree of importance of each of the plurality of regions on the basis of the relationship information.

The specifying section 201, the feature calculation section 202, and the determination section 203 may be computer equipment in which a processor executes a program stored in a memory so that a process is carried out. For example, the specifying section 201, the feature calculation section 202, and the determination section 203 may be provided by a single piece of computer equipment, or may be provided by a computer equipment group that operates through collaboration among pieces of computer equipment or by a server equipment group that operates through collaboration among pieces of server equipment. With the degree-of-importance determination apparatus 200, it is possible to obtain an example advantage equivalent to the example advantage of the degree-of-importance determination system 100. Further, part of the functions may be provided dispersedly in cloud servers.

### Second Example Embodiment

The following description will discuss in detail a second example embodiment of the present invention, with reference to drawings. Note that the same reference numerals are given to constituent elements having the same functions as those described in the first example embodiment, and descriptions of such constituent elements are omitted as appropriate.

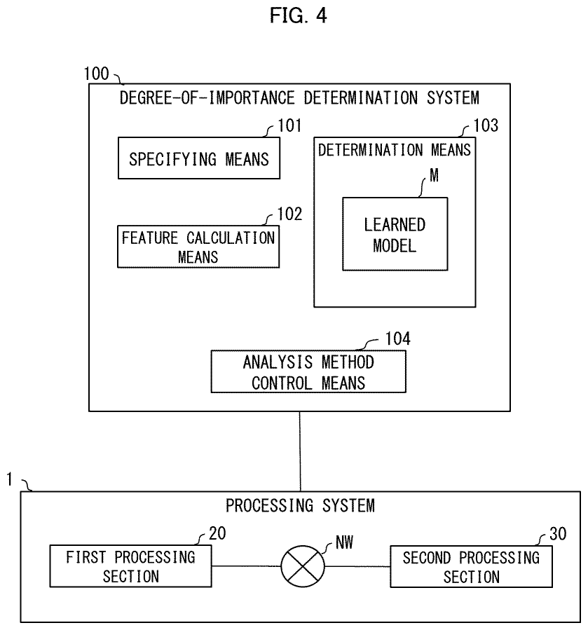

FIG. 4 is a block diagram illustrating an example configuration of a degree-of-importance determination system 100 and a processing system 1 according to the second example embodiment. The degree-of-importance determination system 100 according to the present example embodiment includes a specifying means 101, a feature calculation means 102, a determination means 103, and an analysis method control means 104.

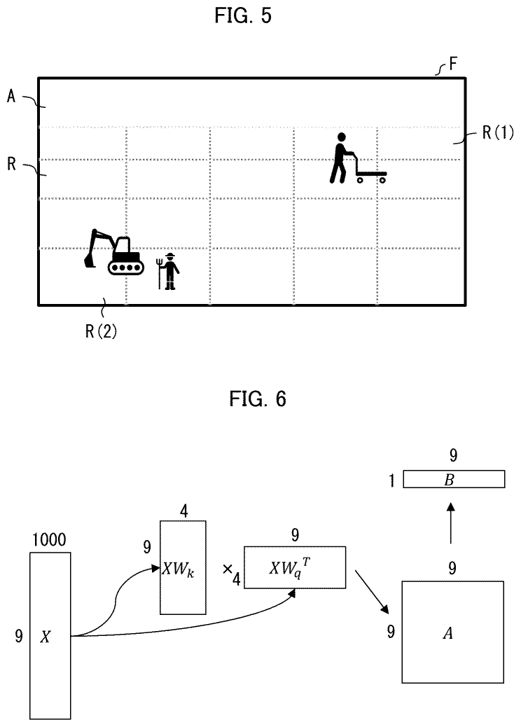

In the present example embodiment, the specifying means 101 specifies a plurality of regions, positions of which are preset, in an input image. FIG. 5 is a schematic view illustrating an example of the regions specified by the specifying means 101 in the present example embodiment. The specifying means 101 divides a single frame F of the input image into predefined regions to specify a plurality of regions R. Note here that the regions R need not be uniform in size, and it is not necessary to specify the regions from the entire frame F.

For example, it is not necessary for the specifying means 101 to specify, as a region, a portion (e.g., sky, a building, etc.) where it is known in advance that an analysis target is not included. For example, as illustrated in FIG. 5, the specifying means 101 may specify the regions R from portions other than a portion A corresponding to the sky.

Further, for example, the specifying means 101 may change a size of a region to be specified, in accordance with a characteristic of an input image or an analysis target. For example, as illustrated in FIG. 5, in accordance with an angle of view of a camera, the specifying means 101 may cause a size of a lower region R(2), in which a near side is shown, to be larger than a size of an upper region R(1), in which a far side is shown. Further, for example, a size of a region to be specified can be increased for a portion where a large analysis target may exist, and can be decreased for a portion where a small analysis target may exist.

In the present example embodiment, the feature calculation means 102 calculates features of the respective plurality of regions. The method of calculating the features is not particularly limited. In an example aspect, the feature calculation means 102 may include, in a feature of each of the plurality of regions, a result of inference of a type of an object included in the each of the plurality of regions. The type of an object indicates, for example, whether the object is a person or a machine, whether the object is an automobile, heavy equipment, or the like, etc. Further, in an example aspect, the feature calculation means 102 may include, in a feature of each of the plurality of regions, a position of the each of the plurality of regions in the input image. The form of representation of the feature is not particularly limited, but can be, for example, a fixed-length vector.

For example, a feature of each of the plurality of regions may be a fixed-length vector which is obtained by combining position information indicative of a position of the each of the plurality of regions in the input image and class information indicative of a result of inference of a type of an object included in the each of the plurality of regions.

The position information may be any information that indicates a position of the region in the input image. For example, the position information may be information calculated in accordance with a pixel position relative to an upper left corner (0,0) of the input image and a lower right corner (1,1) of the input image. The position information may further include a size (width and height) of the region.

The class information may be any information that indicates a result of inference of a type of an object included in the region. For example, the class information indicates an identification result (a class determined by classification) obtained by identification of each region with use of an object identification model. Examples of the object identification model can include an object identification model that has been trained with use of training data of ImageNet or the like. The form of representation of the class information is not particularly limited, but may be, for example, a vector that indicates respective degrees of confidence that various types of identifiable objects are included in the region. For example, a vector for the region R(2) in FIG. 5 may be (automobile: 0.4, truck: 0.1, truck crane: 0.5, . . . , person: 0).

Note that the feature of each region calculated by the feature calculation section 102 is not limited to the above-described ones. For example, it is possible to use a feature calculated with use of a trained model having a convolution layer, such as an auto-encoder.

In the present example embodiment, the determination means 103 determines a degree of importance of each of the plurality of regions with use of a learned model M. In an example aspect, the learned model M is a learned model which: calculates a first matrix from (i) input data which is a combination of features of the respective plurality of regions and (ii) a first parameter which has been pretrained by machine learning; calculates a second matrix from the input data and a second parameter which has been pretrained by machine learning; calculates relationship information on the basis of the first matrix and the second matrix; and calculates a degree of importance of each of the plurality of regions on the basis of the relationship information. For example, the learned model M includes: at least one layer in which a first matrix is calculated from (i) input data which is a combination of features of the respective plurality of regions and (ii) a first parameter which has been pretrained by machine learning; at least one layer in which a second matrix is calculated from the input data and a second parameter which has been pretrained by machine learning; at least one layer in which relationship information is calculated on the basis of the first matrix and the second matrix; and at least one layer in which a degree of importance of each of the plurality of regions is calculated on the basis of the relationship information. As the learned model M, a self-attention model may be used in an example aspect, although the learned model M is not limited to this.

FIG. 6 is a schematic view schematically illustrating an example of the self-attention model. In the example illustrated in FIG. 6, the number of regions is 9, the number of dimensions of features is 1000, and the number of dimensions of a key (first matrix) and the number of dimensions of a query (second matrix) are each 4. However, the number of regions and the numbers of dimensions are not limited to this example.

In the example illustrated in FIG. 6, X is input data which is a combination of features of the respective regions. X is represented as a matrix (9,1000) obtained by combining features of nine regions, in each of which the number of dimensions of features is 1000.

First, in the learning model M, the input data X is multiplied by an attention parameter Wₖ (first parameter) and by an attention parameter W_{q} (second parameter), so that a key XWₖ (first matrix) and a query XW_{q}^{T} (second matrix) are obtained, respectively. The attention parameter Wₖ (first parameter) and the attention parameter W_{q} (second parameter) are parameters which have been trained by machine learning as described later, and are represented as a matrix (1000,4). The obtained key XWₖ is a matrix (9,4), and the query XW_{q}^{T} is a matrix (4,9).

Then, in the learning model M, an attention weight A is generated in accordance with an expression below. Note that dᵢₙ represents the number of dimensions of features. The attention weight A indicates a region whose feature is related to a degree of importance of each region, and the attention weight A is equivalent to the relationship information.

$$A = softmax ( \frac{( {XW}_{k} ) {( {XW}_{q} )}^{T}}{\sqrt{{d}_{i n}}} )$$

Then, by calculation of a sum of attention weights A in a row direction, a degree-of-importance determination result B (1,9) is calculated. Each row of the degree-of-importance determination result B (1,9) represents a degree of importance of each region.

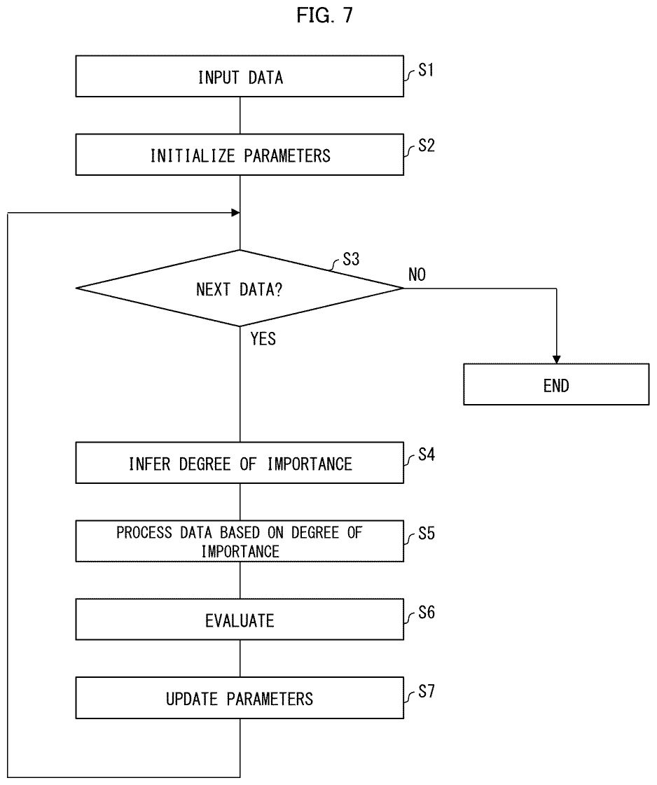

As described above, the attention parameter Wₖ (first parameter) and the attention parameter W_{q} (second parameter) are parameters which have been trained by machine learning. FIG. 7 is a flowchart illustrating an example of a learning method for generating the learned model M.

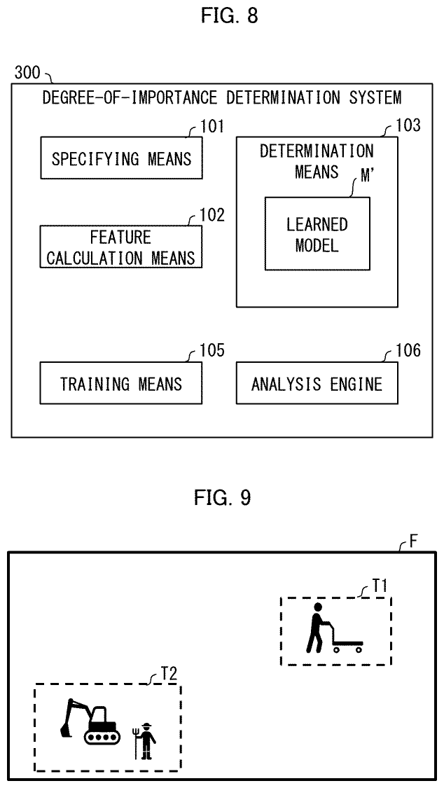

In an example, machine learning for generating the learned model M can be carried out with use of a degree-of-importance determination system 300 as illustrated in FIG. 8. The degree-of-importance determination system 300 includes a specifying means 101, a feature calculation means 102, a determination means 103, a training means 105, and an analysis engine 106.

In step S1, training data is inputted to the training means 105. The training data may be an image to which a label indicating an analysis result is assigned. A reward value used in reinforcement learning may be further set in the label. A plurality of labels each indicating an analysis result may be assigned to a single piece of training data.

For example, data obtained by assigning a label “heavy equipment approaching (10)” and a label “conveyance work (1)” to the image illustrated in FIG. 5 can be used as training data for generating a learned model M to be applied to a construction site. As, for example, training data for generating a learned model M to be applied to factory work, an image to which labels “packaging work (1)”, “installation work (5)”, and “screwing work (10)” are assigned, for example, may be used. A reward value to be set can be such that a high reward value is set to an event having high priority in being detected by analysis.

Further, an image in which a plurality of persons are included may be used as training data, a person may be detected as an analysis target, and a reward value may be set such that: a high reward is given in a case where a region in which a person is included is successfully selected (for example, a reward value of +1 per person included); and the reward is 0 in a case where a region in which nothing is included is selected.

In step S2, the training means 105 initializes parameters (e.g., the attention parameter Wₖ (first parameter) and the attention parameter W_{q} (second parameter)) of a machine learning model M′.

In step S3, the training means 105 determines whether or not training data to be applied next exists, and in a case where there is no training data to be applied next, the training means 105 ends the training.

In step S4, the specifying means 101, the feature calculation means 102, and the determination means 103 carry out determination of a degree of importance in a similar manner to the degree-of-importance determination system 100, except for using the training data in place of the input image and using the machine learning model M′ in place of the learned model M.

In step S5, on the basis of a degree of importance of each of the plurality of regions obtained, the training means 105 subjects the training data to: a process in which only a region having a high degree of importance is cut out; and/or a process in which only a region having a high degree of importance is caused to have high image quality and the other regions are caused to have low image quality.

In step S6, the training means 106 inputs the training data which has been processed in step S5 to the analysis engine 106 to identify an analysis result. Note that the input to the analysis engine may be images of a plurality of frames. The training means 105 calculates a reward value in accordance with the analysis result obtained. That is, in a case where an analysis result indicated by a label assigned to the training data is obtained, the training means 105 may add the reward value set in the label.

In step S7, the training means 106 carries out reinforcement learning by updating the parameters (the attention parameter Wₖ (first parameter) and the attention parameter W_{q} (second parameter)) of the machine learning model M′ on the basis of the reward value calculated in step S6. The method of updating the parameters may be in accordance with a known reinforcement learning method.

Thus, it is possible to generate a learned model M by updating the parameters of the machine learning model M′. Note that the learned model M may be generated in a plurality of types. For example, depending on a scene (construction site, factory work), a time slot (morning, noon, and night), and the like, different learned models M may be generated and used selectively.

The following description will discuss the analysis method control means 104. The analysis method control means 104 controls a method of analysis of each region of the input image in accordance with a degree of importance of the each region determined by the determination means 103.

First, the processing system 1, which carries out an analysis process of analyzing an input image will be described. As illustrated in FIG. 4, the processing system 1 includes at least one first processing section 20 and a second processing section 30. For ease of view, FIG. 4 shows a configuration in which a single first processing section 20 is provided, but there may be a plurality of first processing sections 20.

Each first processing section 20 is connected to a camera, a sensor such as a light detection and ranging (LiDAR), or the like and acquires at least one input image from the camera, the sensor, or the like. It is sufficient that the at least one input image includes an analysis target in an angle of view of the image. The analysis target is, for example, a worker (person) who works at a construction site, a work apparatus (object), and a behavior (operation) of the worker or the work apparatus.

The first processing section 20 may be connected to a plurality of cameras, sensors, or the like to acquire a plurality of input images. The first processing section 20 may acquire a plurality of input images from a single camera or the like.

The first processing section 20 and the second processing section 30 can each be constituted by at least one computer. The first processing section 20 and the second processing section 30 are capable of communicating with each other via a network NW and share an analysis process of analyzing the at least one input image. The network NW may be wireless or wired, and in a case where the network NW is wired, the network NW may be a wireless communication system such as Wi-Fi, LTE, 4G, and 5G.

In an example aspect, the first processing section 20 may be an edge processing section, and the second processing section 30 may be a cloud processing section. In the present specification, an “edge” is a place where data is collected. The first processing section 20 that is an edge processing section is an information processing apparatus (computer) or a group of information processing apparatuses provided in or in the vicinity of a place (e.g., a construction site, a factory, or the like) where an analysis target is present, and the first processing section 20 acquires an input image from a camera, a sensor, or the like provided in the place where the analysis target is present. The first processing section 20 may be integrated with the camera, the sensor, or the like. In the present specification, a “cloud” is a place where storage, processing, and the like of data is carried out. The second processing section 30 that is a cloud processing section may be an information processing apparatus (computer) or a group of information processing apparatuses installed in a place such as a data center or a server farm capable of providing large computing resources. Note that it is only necessary that the second processing section 30 be a processing section that is in a place connected to the first processing section 20 via a network. The second processing section 30 may be: a computing resource (e.g., a multi-access edge computing (MEC)) connected to a base station of 5G or the like; a server (on-premises server) installed in an office on site or the like; or the like.

The first processing section 20 may carry out an analysis process of analyzing at least a part of the acquired at least one input image to generate an analysis result. The first processing section 20 may calculate features of at least a part of the acquired at least one input image and transmit the calculated features to the second processing section 30 via the network NW. The first processing section 20 may transmit at least a part of the acquired at least one input image to the second processing section 30 via the network NW. Note that at the time of transmission of the features or the input image from the first processing section 20 to the second processing section 30, the first processing section 20 may: transmit the features or the input image to the second processing section 30 after subjecting the features or the input image to a compression process or an encryption process; or transmit the features or the input image to the second processing section 30 without subjecting the features or the input image to a compression process or an encryption process.

The second processing section 30 receives the features or the input image transmitted from the first processing section 20, carries out a restoration process as necessary, and carries out an analysis process.

The analysis process is, for example, detection, identification, tracking, and time-series analysis of an analysis target (an object, a person) on the basis of the at least one input image. A learning model may be used in the analysis process. One or both of the first processing section 20 and the second processing section 30 may use a learning model.

The analysis method control means 104 controls the processing system 1 (i.e., the first processing section 20 and the second processing section 30) as below.

In an example, the analysis method control means 104 may control the first processing section 20 to: cut out a region having a high degree of importance out of the at least one input image; deliver the region to the second processing section 30; and discard the remainder. With this, for example, in a case where, for example, a bandwidth of a communication band between the first processing section 20 and the second processing section 30 is reduced, a bit rate can be reduced by delivering only a portion having a high degree of importance.

In an example, the analysis method control means 104 may control the first processing section 20 to: cut out a region having a high degree of importance out of the at least one input image; deliver the region to the second processing section 30; and analyze the remainder. This allows a region having a high degree of importance out of the at least one input image to be analyzed by the second processing section 30 with use of a model with high accuracy, and allows the remaining region to be analyzed by the first processing section 20 with use of a model with low accuracy.

In an example, the analysis method control means 104 may control the first processing section 20 and/or the second processing section 30 to: analyze only a region having a high degree of importance out of the input image; and discard the remaining regions. This makes it possible to carry out analysis focusing only on important portions in a case where it is difficult to analyze all of the regions in terms of computational load.

In an example, the analysis method control means 104 may control the first processing section 20 and/or the second processing section 30 to: analyze, with use of a model with high accuracy, only a region having a high degree of importance out of the at least one input image; and analyze the remaining regions with use of a model with low accuracy. With this, in a case where it is difficult, in terms of computational load, to analyze all of the regions with use of a model with high accuracy, it possible to analyze only a region having a high degree of importance with use of the model with high accuracy and analyze the other regions with use of a model with low accuracy.

As described above, according to the present example embodiment, the region whose degree of importance is to be determined is not limited to a fixed size, and it is possible to determine a degree of importance of a region of a given size in accordance with a characteristic of an input image or an analysis target.

Further, since a degree of importance of each of the plurality of regions is determined with use of a learned model which generates relationship information on the basis of features of the at least one input image, it is possible to determine the degree of importance with use of the relationship information which is in accordance with the at least one input image, and thus to determine the degree of importance accurately.

Further, by controlling a method of analysis of each of the plurality of regions in accordance with a determined degree of importance of the each of the plurality of regions, it is possible to carry out efficient analysis. In particular, in a case where the camera is an omnidirectional camera, a panorama camera, or the like and the amount of data is very large, carrying out a control so as to cause only a region having a high degree of importance to be transmitted from the first processing section 20 to the second processing section 30 makes it possible to deal with a case in which a bandwidth of the network is reduced.

In an example, the analysis method control means 104 may control the processing system 1 (i.e., the first processing section 20 and the second processing section 30) to share the analysis of the analysis target data between the first processing section 20 and the second processing section 30. Note that the analysis method control means 104 does not have to cause the processing system 1 to analyze analysis target data an analysis of which has been determined to be unnecessary.

The sharing of analysis of the analysis target data between the first processing section 20 and the second processing section 30 can be carried out in various manners. Examples of such manners include: a manner in which the first processing section 20 which has acquired the analysis target data carries out all of the process of analyzing the analysis target data; a manner in which the first processing section 20 which has acquired the analysis target data carries out the analysis process to some extent, and the second processing section 30 carries out the remaining analysis process; and a manner in which the first processing section 20 carries out minimum necessary processing such as compression, and the second processing section 30 carries out all of the analysis process of the analysis target data. For example, a sharing method of analysis target data may be selected in accordance with the calculation capacity of the first processing section 20 or the like, from among: a first sharing method of causing the first processing section 20 to generate an analysis result of analyzing the analysis target data; a second sharing method of causing the first processing section 20 to calculate features of the analysis target data, causing the first processing section 20 to transmit the features to the second processing section 30, and causing the second processing section 30 to generate an analysis result from the features; and a third sharing method of causing the first processing section 20 to transmit the analysis target data to the second processing section 30 and causing the second processing section 30 to generate an analysis result from the analysis target data. Criteria used in the selection of a sharing method may be computational cost, a degree of importance of the analysis target data, a degree of risk indicated by the analysis target data, and an efficiency of compression of each piece of the analysis target data, communication quality, and the like, as well as computational power. By selectively using these sharing methods, it is possible to efficiently carry out an analysis process in accordance with situations.

Note here that the analysis method control means 104 may select, for each of the at least one input image acquired by each first processing section 20, a sharing method in accordance with a degree of importance of each of the at least one input image. For example, an input image that has a high degree of importance may be analyzed promptly by being analyzed by the first processing section 20 which has acquired the input image, and an input image that has a high degree of importance may be analyzed accurately by being analyzed by the second processing section 30.

In another example aspect, the analysis method control means 104 may select a sharing method such that whether analysis target data is to be analyzed by the first processing section 20 or by the second processing section 30 is switched depending on (i) a predicted load of processing of the analysis target data by the first processing section 20 and (ii) a predicted bandwidth of a communication band between the first processing section 20 and the second processing section 30. The analysis method control means 104 may also determine, on the basis of the predicted bandwidth of the communication band, an analysis target data portion to be discarded in the analysis target data. The analysis method control means 104 may also cause the first processing section 20 and the second processing section 30 to, in a case where switching has been made from not processing analysis target data to processing the analysis target data, interpolate a frame in a unit frame set which frame was being processed before the switching. The analysis method control means 104 may also (i) cause a processing section which is one of the first processing section 20 and the second processing section 30 and which is not analyzing analysis target data to buffer the analysis target data and (ii) in a case where the processing section which is not processing the analysis target data has come to process the analysis target data, cause the processing section which has not been processing the analysis target data to analyze the analysis target data with use of the buffered data. Note that the process control means 102 may carry out the discard process, the interpolation process, and the buffering process described above on the basis of: a degree of importance of the analysis target data; a degree of reliability of processing of the analysis target data; a bandwidth of a communication band allocated for transmission of the analysis target data; and the like. Note that the degree of reliability is an index indicating how much confidence is in a predicted analysis result, and may be, for example, a confidence value outputted from a learned model that has carried out the analysis.

Note that although the above description has discussed a configuration in which the degree-of-importance determination system 100 is independent of each first processing section 20 and the second processing section 30, the present example embodiment is not limited to this. For example, all or part of the degree-of-importance determination system 100 may be provided in each first processing section 20 or the second processing section 30 or may be dispersedly provided in the at least one first processing section 20 and the second processing section 30.

The second example embodiment has thus been described as the process control system 100. The second example embodiment may also be a process control apparatus obtained by providing the process control system 100 according to the second example embodiment in a single apparatus. The operation of the process control system 100 according to the second example embodiment may be a process control method according to the second example embodiment.

### Third Example Embodiment

The following description will discuss in detail a third example embodiment of the present invention, with reference to drawings. Note that the same reference numerals are given to constituent elements having the same functions as those described in the first and second example embodiments, and descriptions of such constituent elements are omitted as appropriate.

In the present example embodiment, a specifying means 101 detects a plurality of objects included in at least one input image and specifies a plurality of regions by specifying regions corresponding to the respective plurality of objects detected. FIG. 9 is a schematic view illustrating an example of the regions specified by the specifying means 101 in the present example embodiment. The specifying means 101 specifies a plurality of regions T1 and T2 in a single frame F of the at least one input image by specifying regions corresponding to the respective plurality of objects detected with use of an object detection model. Each region corresponding to an object is, for example, a region surrounding the object.

In the present example embodiment, a feature calculation means 102 calculates features of the respective plurality of regions in a similar manner to the feature calculation means 102 according to the second example embodiment. In so doing, as with the feature calculation means 102 according to the second example embodiment, the feature calculation means 102 may use, as class information, an identification result obtained by identification of each region with use of an object identification model. Alternatively, the feature calculation means 102 may use, as class information, an identification result which was obtained at the time of detection of an object in the at least one input image by object detection carried out by the specifying means 101.

Thus, according to the present example embodiment, the region whose degree of importance is to be determined can be a region of a given size in which an object has been detected. This makes it possible to determine a degree of importance efficiently.

The third example embodiment has thus been described as the process control system 100. The third example embodiment may also be a process control apparatus obtained by providing the process control system 100 according to the third example embodiment in a single apparatus. The operation of the process control system 100 according to the third example embodiment may be a process control method according to the third example embodiment.

### Fourth Example Embodiment

The following description will discuss in detail a fourth example embodiment of the present invention, with reference to drawings. Note that the same reference numerals are given to constituent elements having the same functions as those described in the first, second, and third example embodiments, and descriptions of such constituent elements are omitted as appropriate.

In the present example embodiment, the specifying means 101 specifies a plurality of regions by specifying at least one region in each of a plurality of input images inputted from cameras that differ from each other.

In the present example embodiment, a feature calculation means 102 calculates a feature of each of the at least one region in each of the plurality of input images. The determination means 103 is capable of determining a degree of importance of each of the regions in the plurality of input images by inputting, to a learned model M, input data which is a combination of features of the regions in the plurality of input images.

Thus, it is possible to carry out determination of a degree of importance across a plurality of cameras by inputting, to a learned model, input data which is a combination of features of regions in a plurality of input images, instead of inputting features to a learned model for each input image.

The fourth example embodiment has thus been described as the process control system 100. The fourth example embodiment may also be a process control apparatus obtained by providing the process control system 100 according to the fourth example embodiment in a single apparatus. The operation of the process control system 100 according to the fourth example embodiment may be a process control method according to the fourth example embodiment.

The present disclosure is not limited to the example embodiments described above, but can be altered by a skilled person in the art in various ways. The present disclosure also encompasses, in its technical scope, any example embodiment derived by combining, as appropriate, configurations, operations, and processes disclosed in differing example embodiments. The present disclosure also encompasses, in its technical scope, anything derived by altering, as appropriate, the order of operations or processes disclosed in differing example embodiments.

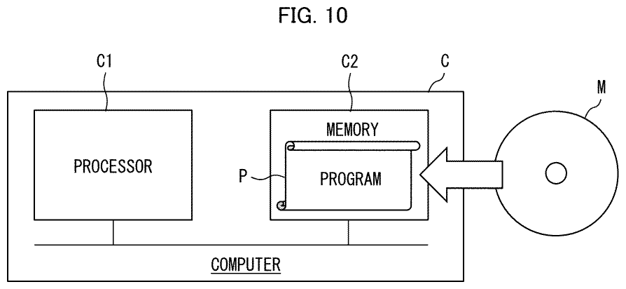

Each of the components according to the first to fourth example embodiments may be configured via (1) a single piece of hardware or a plurality of pieces of hardware, (2) a single piece of software or a plurality of pieces of software, (3) a combination of hardware and software, or (4) a second. Each apparatus, each function, and each process may be provided with use of at least one computer including at least one processor and at least one memory. FIG. 10 illustrates an example of such a computer (hereinafter, referred to as “computer C”). For example, a program for carrying out the process control methods described in the first to fourth example embodiments may be stored in a memory C2, and the processor C1 may retrieve and execute the program P stored in the memory C2, so that the functions described in the first to fourth example embodiments may be implemented.

The program P contains a set of instructions to, in a case where the program P is loaded into the computer C, causes the computer C to carry out one or more of the functions described in the first to fourth example embodiments. The program P is stored in the memory C2. Examples of the processor C1 can encompass a central processing unit (CPU). Examples of the memory C2 can encompass a read only memory (ROM), a random access memory (RAM), a flash memory, and a solid state drive (SSD).

The program P can also be recorded in a non-transitory tangible recording medium M from which the computer C can read the program P. Examples of such a recording medium M can include a tape, a disk, a card, a semiconductor memory, and a programmable logic circuit. The computer C can obtain the program P via such a recording medium M. Alternatively, the program P can be transmitted via a transmission medium. Examples of such a transmission medium can include a communication network and a broadcast wave. The computer C can acquire the program P also via the transmission medium.

The present disclosure is not limited to the example embodiments described above. That is, the present invention can apply, within the scope of the present disclosure, various example aspects that could be understood by a person skilled in the art. All or some of the example embodiments described above can also be described as below. Note, however, that the present invention not is limited to the following supplementary notes.

### (Supplementary Note 1)

A degree-of-importance determination system for determining a degree of importance of each of a plurality of regions in at least one input image, the degree-of-importance determination system including:
a specifying means that specifies the plurality of regions in the at least one input image;
a feature calculation means that calculates features of the respective plurality of regions; and
a determination means that generates, on the basis of the features of the respective plurality of regions, relationship information indicative of a relationship between the features of the respective plurality of regions and determines the degree of importance of each of the plurality of regions on the basis of the relationship information.

### (Supplementary Note 2)

The degree-of-importance determination system described in supplementary note 1, wherein the determination means: calculates a first matrix from (i) input data which is a combination of the features of the respective plurality of regions and (ii) a first parameter which has been pretrained by machine learning; calculates a second matrix from the input data and a second parameter which has been pretrained by machine learning; calculates the relationship information on the basis of the first matrix and the second matrix; and calculates the degree of importance of each of the plurality of regions on the basis of the relationship information.

### (Supplementary Note 3)

The degree-of-importance determination system described in supplementary note 1 or 2, wherein the feature calculation means includes, in a feature of each of the plurality of regions, a result of inference of a type of an object included in the each of the plurality of regions.

### (Supplementary Note 4)

The degree-of-importance determination system described in any one of supplementary notes 1 to 3, wherein the feature calculation means includes, in a feature of each of the plurality of regions, a position of the each of the plurality of regions in the at least one input image.

### (Supplementary Note 5)

The degree-of-importance determination system described in any one of supplementary notes 1 to 4, wherein the specifying means specifies the plurality of regions which have respective sizes that are of two or more types and each of which is in a preset position in the at least one input image.

### (Supplementary Note 6)

The degree-of-importance determination system described in any one of supplementary notes 1 to 4, wherein the specifying means detects a plurality of objects included in the at least one input image and specifies the plurality of regions by specifying regions corresponding to the respective plurality of objects detected.

### (Supplementary Note 7)

The degree-of-importance determination system described in any one of supplementary notes 1 to 6, wherein the specifying means specifies the plurality of regions by specifying at least one region in each of a plurality of input images inputted from cameras that differ from each other.

### (Supplementary Note 8)

The degree-of-importance determination system described in any one of supplementary notes 1 to 7, further including an analysis method control means that controls, in accordance with the degree of importance of each of the plurality of regions, a method of analysis of the each of the plurality of regions.

### (Supplementary Note 9)

A degree-of-importance determination apparatus for determining a degree of importance of each of a plurality of regions in at least one input image, the degree-of-importance determination apparatus including:
a specifying section that specifies the plurality of regions in the at least one input image;
a feature calculation section that calculates features of the respective plurality of regions;
a feature calculation means that calculates features of the respective plurality of regions; and
a determination section that generates, on the basis of the features of the respective plurality of regions, relationship information indicative of a relationship between the features of the respective plurality of regions and determines the degree of importance of each of the plurality of regions on the basis of the relationship information.

### (Supplementary Note 10)

The degree-of-importance determination apparatus described in supplementary note 9, wherein the determination section: calculates a first matrix from (i) input data which is a combination of the features of the respective plurality of regions and (ii) a first parameter which has been pretrained by machine learning; calculates a second matrix from the input data and a second parameter which has been pretrained by machine learning; calculates the relationship information on the basis of the first matrix and the second matrix; and calculates the degree of importance of each of the plurality of regions on the basis of the relationship information.

### (Supplementary Note 11)

The degree-of-importance determination apparatus described in supplementary note 9 or 10, wherein the feature calculation section includes, in a feature of each of the plurality of regions, a result of inference of a type of an object included in the each of the plurality of regions.

### (Supplementary Note 12)

The degree-of-importance determination apparatus described in any one of supplementary notes 9 to 11, wherein the feature calculation section includes, in a feature of each of the plurality of regions, a position of the each of the plurality of regions in the at least one input image.

### (Supplementary Note 13)

The degree-of-importance determination apparatus described in any one of supplementary notes 9 to 12, wherein the specifying section specifies the plurality of regions which have respective sizes that are of two or more types and each of which is in a preset position in the at least one input image.

### (Supplementary Note 14)

The degree-of-importance determination apparatus described in any one of supplementary notes 9 to 12, wherein the specifying section detects a plurality of objects included in the at least one input image and specifies the plurality of regions by specifying regions corresponding to the respective plurality of objects detected.

### (Supplementary Note 15)

The degree-of-importance determination apparatus described in any one of supplementary notes 9 to 14, wherein the specifying section specifies the plurality of regions by specifying at least one region in each of a plurality of input images inputted from cameras that differ from each other.

### (Supplementary Note 16)

The degree-of-importance determination apparatus described in any one of supplementary notes 9 to 15, further including an analysis method control section that controls, in accordance with the degree of importance of each of the plurality of regions, a method of analysis of the each of the plurality of regions.

### (Supplementary Note 17)

A degree-of-importance determination method for determining a degree of importance of each of a plurality of regions in at least one input image, the degree-of-importance determination method including:
specifying the plurality of regions in the at least one input image;
calculating features of the respective plurality of regions;
a feature calculation means that calculates features of the respective plurality of regions; and
generating, on the basis of the features of the respective plurality of regions, relationship information indicative of a relationship between the features of the respective plurality of regions and determining the degree of importance of each of the plurality of regions on the basis of the relationship information.

### (Supplementary Note 18)

The degree-of-importance determination method described in supplementary note 17, wherein: a first matrix is calculated from (i) input data which is a combination of the features of the respective plurality of regions and (ii) a first parameter which has been pretrained by machine learning; a second matrix is calculated from the input data and a second parameter which has been pretrained by machine learning; the relationship information is calculated on the basis of the first matrix and the second matrix; and the degree of importance of each of the plurality of regions is calculated on the basis of the relationship information.

### (Supplementary Note 19)

The degree-of-importance determination method described in supplementary note 17 or 18, wherein a feature of each of the plurality of regions includes a result of inference of a type of an object included in the each of the plurality of regions.

### (Supplementary Note 20)

The degree-of-importance determination method described in any one of supplementary notes 17 to 19, wherein a feature of each of the plurality of regions includes a position of the each of the plurality of regions in the at least one input image.

### (Supplementary Note 21)

The degree-of-importance determination method described in any one of supplementary notes 17 to 20, wherein the plurality of regions which have respective sizes that are of two or more types and each of which is in a preset position in the at least one input image are specified.

### (Supplementary Note 22)

The degree-of-importance determination method described in any one of supplementary notes 17 to 20, wherein a plurality of objects included in the at least one input image are detected, and the plurality of regions are specified by specifying regions corresponding to the respective plurality of objects detected.

### (Supplementary Note 23)

The degree-of-importance determination method described in any one of supplementary notes 17 to 22, wherein the plurality of regions are specified by specifying at least one region in each of a plurality of input images inputted from cameras that differ from each other.

### (Supplementary Note 24)

The degree-of-importance determination method described in any one of supplementary notes 17 to 23, wherein a method of analysis of each of the plurality of regions is controlled in accordance with the degree of importance of the each of the plurality of regions.

### (Supplementary Note 25)

The process control system described above can also be expressed as below.

A degree-of-importance determination system for determining a degree of importance of each of a plurality of regions in at least one input image, the degree-of-importance determination system including
at least one processor, the at least one processor carrying out:
a specifying process of specifying the plurality of regions in the at least one input image;
a feature calculation process of calculating features of the respective plurality of regions; and
a determination process of generating, on the basis of the features of the respective plurality of regions, relationship information indicative of a relationship between the features of the respective plurality of regions and determining the degree of importance of each of the plurality of regions on the basis of the relationship information.

Note that the process control system may further include at least one memory, which may store a program for causing the at least one processor to carry out the specifying process, the feature calculation process, and the determination process. Further, the program can also be stored in a computer-readable non-transitory tangible storage medium.

### (Supplementary Note 26)

The process control system described above can also be expressed as below.

A degree-of-importance determination apparatus for determining a degree of importance of each of a plurality of regions in at least one input image, the degree-of-importance determination apparatus including:
at least one processor, the at least one processor carrying out:
a specifying process of specifying the plurality of regions in the at least one input image;
a feature calculation process of calculating features of the respective plurality of regions; and
a determination process of generating, on the basis of the features of the respective plurality of regions, relationship information indicative of a relationship between the features of the respective plurality of regions and determining the degree of importance of each of the plurality of regions on the basis of the relationship information.

Note that the process control system may further include at least one memory, which may store a program for causing the at least one processor to carry out the specifying process, the feature calculation process, and the determination process. Further, the program can also be stored in a computer-readable non-transitory tangible storage medium.

### REFERENCE SIGNS LIST

1: Processing system
10: Camera
20: First processing section
30: Second processing section
100: Degree-of-importance determination system
101: Specifying means
102: Feature calculation means
103: Determination means
104: Analysis method control means 104
M: Learned model

What is claimed is:

1. A degree-of-importance determination system for determining a degree of importance of each of a plurality of regions in at least one input image, the degree-of-importance determination system comprising at least one processor, the at least one processor carrying out:
a specifying process of specifying the plurality of regions in the at least one input image;
a feature calculation process of calculating features of the respective plurality of regions; and
a determination process of generating, on the basis of the features of the respective plurality of regions, relationship information indicative of a relationship between the features of the respective plurality of regions and determining the degree of importance of each of the plurality of regions on the basis of the relationship information.

2. The degree-of-importance determination system according to claim 1, wherein in the determination process, the at least one processor: calculates a first matrix from (i) input data which is a combination of the features of the respective plurality of regions and (ii) a first parameter which has been pretrained by machine learning; calculates a second matrix from the input data and a second parameter which has been pretrained by machine learning; calculates the relationship information on the basis of the first matrix and the second matrix; and calculates the degree of importance of each of the plurality of regions on the basis of the relationship information.

3. The degree-of-importance determination system according to claim 1, wherein in the feature calculation process, the at least one processor includes, in a feature of each of the plurality of regions, a result of inference of a type of an object included in the each of the plurality of regions.

4. The degree-of-importance determination system according to claim 1, wherein in the feature calculation process, the at least one processor includes, in a feature of each of the plurality of regions, a position of the each of the plurality of regions in the at least one input image.

5. The degree-of-importance determination system according to claim 1, wherein in the specifying process, the at least one processor specifies the plurality of regions which have respective sizes that are of two or more types and each of which is in a preset position in the at least one input image.

6. The degree-of-importance determination system according to claim 1, wherein in the specifying process, the at least one processor detects a plurality of objects included in the at least one input image and specifies the plurality of regions by specifying regions corresponding to the respective plurality of objects detected.

7. The degree-of-importance determination system according to claim 1, wherein in the specifying process, the at least one processor specifies the plurality of regions by specifying at least one region in each of a plurality of input images inputted from cameras that differ from each other.

8. A degree-of-importance determination apparatus for determining a degree of importance of each of a plurality of regions in at least one input image, the degree-of-importance determination apparatus comprising at least one processor, the at least one processor carrying out:
a specifying process of specifying the plurality of regions in the at least one input image;
a feature calculation process of calculating features of the respective plurality of regions;
and
a determination process of generating, on the basis of the features of the respective plurality of regions, relationship information indicative of a relationship between the features of the respective plurality of regions and determining the degree of importance of each of the plurality of regions on the basis of the relationship information.

9. The degree-of-importance determination apparatus according to claim 8, wherein in the determination process, the at least one processor: calculates a first matrix from (i) input data which is a combination of the features of the respective plurality of regions and (ii) a first parameter which has been pretrained by machine learning; calculates a second matrix from the input data and a second parameter which has been pretrained by machine learning; calculates the relationship information on the basis of the first matrix and the second matrix; and calculates the degree of importance of each of the plurality of regions on the basis of the relationship information.

10. The degree-of-importance determination apparatus according to claim 8, wherein in the feature calculation process, the at least one processor includes, in a feature of each of the plurality of regions, a result of inference of a type of an object included in the each of the plurality of regions.

11. The degree-of-importance determination apparatus according to claim 8, wherein in the feature calculation process, the at least one processor includes, in a feature of each of the plurality of regions, a position of the each of the plurality of regions in the at least one input image.

12. The degree-of-importance determination apparatus according to claim 8, wherein in the specifying process, the at least one processor specifies the plurality of regions which have respective sizes that are of two or more types and each of which is in a preset position in the at least one input image.

13. The degree-of-importance determination apparatus according to claim 8, wherein in the specifying process, the at least one processor detects a plurality of objects included in the at least one input image and specifies the plurality of regions by specifying regions corresponding to the respective plurality of objects detected.

14. A degree-of-importance determination method for determining a degree of importance of each of a plurality of regions in at least one input image, the degree-of-importance determination method comprising:
specifying the plurality of regions in the at least one input image by at least one processor;
calculating features of the respective plurality of regions by the at least one processor;
and
generating, by the at least one processor on the basis of the features of the respective plurality of regions, relationship information indicative of a relationship between the features of the respective plurality of regions and determining the degree of importance of each of the plurality of regions by the at least one processor on the basis of the relationship information.

15. The degree-of-importance determination method according to claim 14, wherein the at least one processor: calculates a first matrix from (i) input data which is a combination of the features of the respective plurality of regions and (ii) a first parameter which has been pretrained by machine learning; calculates a second matrix from the input data and a second parameter which has been pretrained by machine learning; calculates the relationship information on the basis of the first matrix and the second matrix; and calculates the degree of importance of each of the plurality of regions on the basis of the relationship information.

16. The degree-of-importance determination method according to claim 14, wherein the at least one processor includes, in a feature of each of the plurality of regions, a result of inference of a type of an object included in the each of the plurality of regions.

17. The degree-of-importance determination method according to claim 14, wherein the at least one processor includes, in a feature of each of the plurality of regions, a position of the each of the plurality of regions in the at least one input image.

18. The degree-of-importance determination method according to claim 14, wherein the at least one processor specifies the plurality of regions which have respective sizes that are of two or more types and each of which is in a preset position in the at least one input image.

19. The degree-of-importance determination method according to claim 14, wherein the at least one processor: detects a plurality of objects included in the at least one input image; and specifies the plurality of regions by specifying regions corresponding to the respective plurality of objects detected.

20. The degree-of-importance determination method according to claim 14, wherein the at least one processor specifies the plurality of regions by specifying at least one region in each of a plurality of input images inputted from cameras that differ from each other.
